(19) United States
(12) Patent Application Publication
(10) Pub. No.: US 2011/0227332 A1
(43) Pub. Date: Sep. 22, 2011

(54) PUMP-HYDRANT QUICK-CONNECTOR AS WELL AS A PUMPING STATION CONTAINING A PUMP-HYDRANT QUICK-CONNECTOR

(76) Inventor: Miroslaw Szuster, Biala (PL)

(21) Appl. No.: 12/671,986

(22) PCT Filed: Aug. 4, 2008
(86) PCT No.: PCT/PL08/00058

§ 371 Date: Jun. 7, 2011

(30) Foreign Application Priority Data
Aug. 3, 2007 (PL) P383072

(51) Int. Cl. F16L 37/248

(52) U.S. Cl. 285/33

(57) ABSTRACT

The subject of the present invention is a pump-hydrant quick-connector (1) possessing an inflow/outflow conduit (2) terminating with a sealing flange (3) made in the form of a symmetrical funnel (6) widened at one end, and a compression pipe (5) possessing a guiding element (7), which determines the essentially co-axial positioning of the compression pipe (5) with a sealing piston (4), upon its connection to and disconnection from the interior surface of the symmetrical funnel (6) of the sealing flange (3). A subject of the present invention is also a pump station containing the pump-hydrant quick-link (1), which is connected directly to the side wall of the tank (36).

The subject of the present invention is a pump or hydrant quick-connector as well as a pumping station containing a pump or hydrant quick-connector, particularly for sewage and wastewater pumping stations.

The subject of the present invention may be used in other pumping installations, including, waterworks, in water and pneumatic conduits, and its solutions may also be used in the modernization of extant tank-based sewage pumping stations.

Classic tank-based sewage pumping stations are well known and commonplace using submersible sewage pumps automatically mounted on connector feet submersed with in the sewage pumped by them. In improved versions, the sewage pumping station tanks usually posses appropriately profiled rounded or conical bottoms, which improves the hygienic conditions of these pumping stations. Furthermore, they may be equipped with devices controlling the pumps in order to remove floating contaminants, which make it possible to lower the sewage level to the level of the submersible pump intake, as well as having automatic rinsing valves which assist in the removal of bottom sediments. However, the working conditions of such improved pumping stations have not improved markedly, and their production costs have increased drastically.

Small-volume sewage pumping stations often make use of an overhead pin connector, in which the pump along with a section of forced flow conduit is suspended on pins or bolts above the water. Various types of this connector are known, as for example from the patent description PCT/HU2004/000008 (WO 2004/067864 A1).

The drawback of this type of pin connector is that such connections often lose their water tightness, which causes flooding in some pumping stations by the activity of other pumping stations connected by a common pressure grid. Furthermore, such connectors are often made of cast iron, which in the corrosive environment of a sewage pumping station strongly corrodes, such that this connector may become jammed, obstructing both its disconnection and subsequent reconnection. The unreliable integrity of a classic pin connector is mainly due to the side seal of this connector and solely due to pump weight. Such a connection requires maintenance, and as a consequence requires operator entry into the tank in very unhygienic conditions.

Pumping stations are often equipped with rinsing connectors, which comprise a separate system in the waterworks, and are located on a return valve and beyond it. This means that during pipe rinsing, the pin connector may become unsealed and/or the return valve may be damaged.

Pumping stations located in dry tanks are also known, where the significant problem is in the connection of the pump with an aspiring conduit. Typical collar connectors are very difficult to use during the de-assembly and subsequent re-assembly of the pump combined with the lack of a simple to use quick-connector.

In addition to the more common methods, air bleed systems are also used, located in the sheathing column, whose task is to bleed of air or aerate pipe networks. In the sheathing column known from the description DE 20 2007 001 179, an air bleed valve is mounted on the inflow pipe, wherein the air bleed valve piston with two seals in its grooves is mounted in a cylindrical sealing collar. This quick-connector, however, requires very precise guidance of the co-axial air bleed valve piston in relation to the collar in order to seal this connection. The main pipe along with the air bleed valve is blocked on the sheathing column using a spindle guide on the side wall of the sheathing pipe, which makes the use of the air bleed valve difficult, nor of the exchange of this valve for a rinsing or receptacle system also mounted on this guide. Due to the construction of the seals of this type of connection, it cannot be used in pressurised sewage systems.

More stringent requirements in terms of environmental friendliness, pump system reliability, low purchase and exploitation costs influence water and sewage operator approaches said questions and are reason for researching optimal solutions for sewage pumping stations, particularly those containing faecal matter.

Due to this, the requirements of water and sewage operators supported by ever more restrictive environmental protection regulation in inhabited zones near sewage works, as well as ensuring maximally hygienic conditions for their employees, research continues on eliminating unpleasant and dangerous odours, including the making of closed-circuit sewage systems, as well as ensuring their greater utility and reliability.

Therefore, the above factors, and in particular the minimalisation of workplace exposure times to a sewage environment as well as under field conditions should be under particular consideration in modern sewage pumping station solutions.

Thus, a real need exists for the construction of such a pump/hydrant quick-connector as well as sewage pumping stations containing a universal pump-hydrant connector, which would fulfil these expectations.

The above requirements may be fulfilled by a pump or hydrant quick-connector as well as a sewage pumping station containing a pump or hydrant quick-connector, in which, most preferentially, at least one connecting element is manufactured from stainless steel or a synthetic material.

The basis of the present invention lays in the fact that a pump or hydrant quick-connector with an inflow/outflow conduit a with a gasket ring as well as a compression pipe with a sealing piston, possesses a sealing flange, which is formed into a widening funnel shape, and the compression pipe possesses a guide element, which markedly determines the co-axial positioning of the compression pipe with the sealing piston, when it is being connected to and disconnected from the interior surface of the symmetrical funnel of the sealing flange.

In the first embodiment variant of the present invention, the interior surface of the compression pipe possesses at least two perpendicular compression bolts, and a guiding pipe is attached to the interior of the widened end of the symmetrical funnel, whose end is equipped with guiding grooves for guiding compression bolts along with the compression pipe, upon its connection to and disconnection from the interior surface of the symmetrical funnel of the sealing flange.

Preferentially, the guiding grooves made in the end of the compression pipe are mirror-image symmetrical and possess bevelled lengthwise edges at an angle _ in relation to the axis of symmetry of the compression pipe, which angle is in the range from 45° do 88°.

The bevelled edges of the guiding grooves are preferentially at an angle _ in relation to the compression pipe, which angle is preferentially in the range from 75° to 83°, and the bevelled edges are terminated with an opening of a diameter wider than the width of the guiding grooves, wherein the bevelled edge of the guiding pipe located closer to the widened end of the symmetrical funnel, abuts the opening.

In a second embodiment variant of the present invention, the guiding pipe is equipped with a lever support, which an attached rotating lever with two symmetrically placed compression arms as well as a mounting arm with a mounting aperture.

Preferentially, the compression pipe possesses a compression support with a compression aperture, which serves to block the mounting arm of the lever.

Preferentially, the lever is blocked by the connection of the mounting aperture of the mounting arm of the lever with the compression aperture of the compression support using a cotter pin.

Preferentially, the guiding element is mounted on the compression pipe opposite the sealing piston and possesses a guiding seal with a diameter equal to or slightly smaller than the internal diameter of the internal guiding pipe.

In the third embodiment variant of the present invention, the external surface of the compression pipe is mounted with at least two perpendicular compression studs, and a sheathing pipe is affixed directly or indirectly to the sealing flange, with an internal diameter greater than the symmetrical funnel of the sealing flange, on which are two guiding grooves for guiding the compression bolts along with the compression pipe, upon its connection to and disconnection from the symmetrical funnel of the sealing flange through the sealing flange.

Preferentially, the guiding element is mounted is on the compression pipe opposite the sealing piston in the form of a concentrically mounted ring attached to the compression bolts, with a diameter equal to or slightly smaller than the internal diameter of the sheathing pipe.

In the fourth embodiment variant of the present invention, a guiding flange is attached perpendicularly to the widened end of the symmetrical funnel of the sealing flange, which contains guiding grooves, a to the compression pipe, opposite the sealing piston, there is attached perpendicularly a compression flange containing at least two guiding elements in the form of guiding studs, which along with the compression pipe pass essentially in a sidewise motion through the guiding grooves, upon its connection to and disconnection from the symmetrical funnel sealing flange.

Preferentially, the sealing piston possesses an end flange as well as a middle flange, with a o-ring type seal wedged between them with an external diameter larger than the external diameter of the flanges, but smaller than the largest internal diameter of the symmetrical funnel of the sealing flange.

Preferentially, in the first, second, and third embodiment variants of the present invention, a compression bolt is affixed to the compression pipe, opposite the sealing piston.

Preferentially, in the first, second, and third embodiment variants of the present invention, the inflow/outflow conduit is connected with a stopper elbow-bend which possesses a terminal elbow-bend with a shutoff valve.

Preferentially, n the first, second, and third embodiment variants of the present invention, the inflow/outflow conduit is connected with a stopper elbow-bend which possesses a terminal elbow-bend return valve with a shutter valve.

A pumping station according to the present invention possesses a pump-hydrant quick-connector attached directly onto the side wall of a tank.

In the first embodiment variant, the pump-hydrant quick-connector is attached directly to the internal side wall of the tank.

Preferentially, the inflow/outflow conduit to the pump-hydrant quick-connector penetrates the tank wall to the outside through a sealed joint, is mounted rigidly onto the tank wall via a resistance flange affixed with a nut, as well as a compression band tightened on the main pipe attached rigidly to the side wall of the tank.

In the second embodiment variant, the pump-hydrant quick-connector is attached directly to the external corrugated wall of the tank.

Preferentially, in the second embodiment variant, the main pipe is attached to the external corrugated wall of the tank using at least two bands mounted in the ring divots of the corrugated wall of the tank.

A quick-connector according to the present invention makes it possible to simplify the construction of this type of above-water connection in household sewage pumping stations as well as the rinsing/receptacle piping of water and sewage installations and by the same token, in aeration/deaeration systems. It also facilitates faster assembly and disassembly of pumps in installations with dry tanks in sewage pumping stations. Furthermore, the attachment of a rinsing connector in place of the connection of the bolt-locked pump connector makes it possible to eliminate an additional valve and alleviates the danger of damage from high rinsing pressures. This forces the operator to disconnect the quick-connector and to rinse it out, a desirable maintenance procedure. The construction of the quick-connector according to the present invention makes it possible to use it not only the pressurised potable water installations, but also in pressurised sewage installations, making it more universal.

The subject of the present invention is better illustrated in example embodiments in the Figures, in which

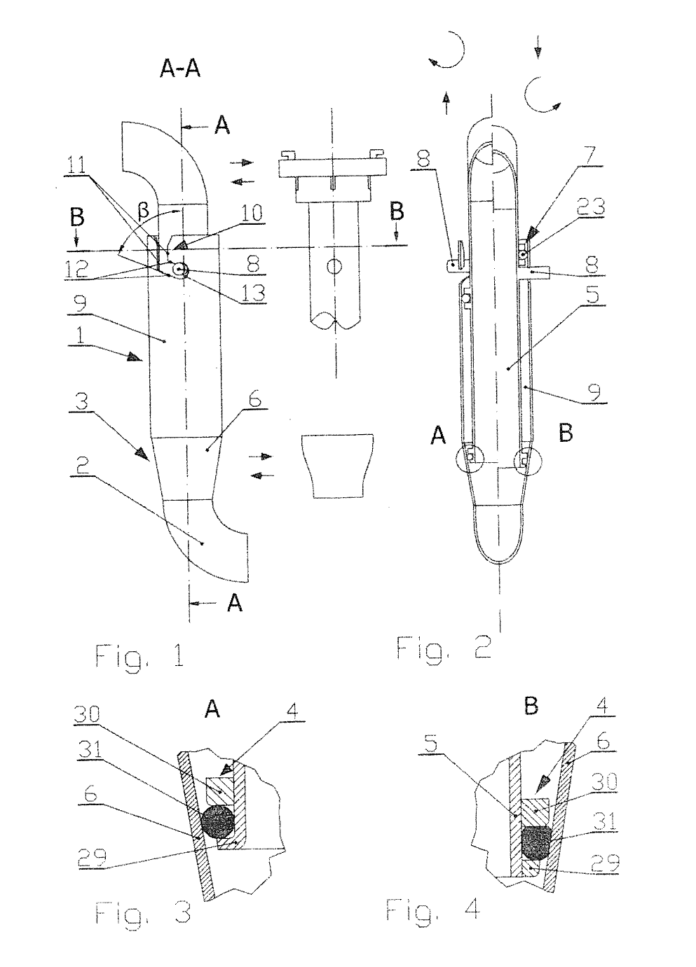

FIG. 1 represents a side view of the quick-connector, of the first embodiment variant in two mounting versions,

FIG. 2 represents the quick-connector in lengthwise section w of the first example embodiment, and

FIG. 3 represents detail A from FIG. 2, whereas

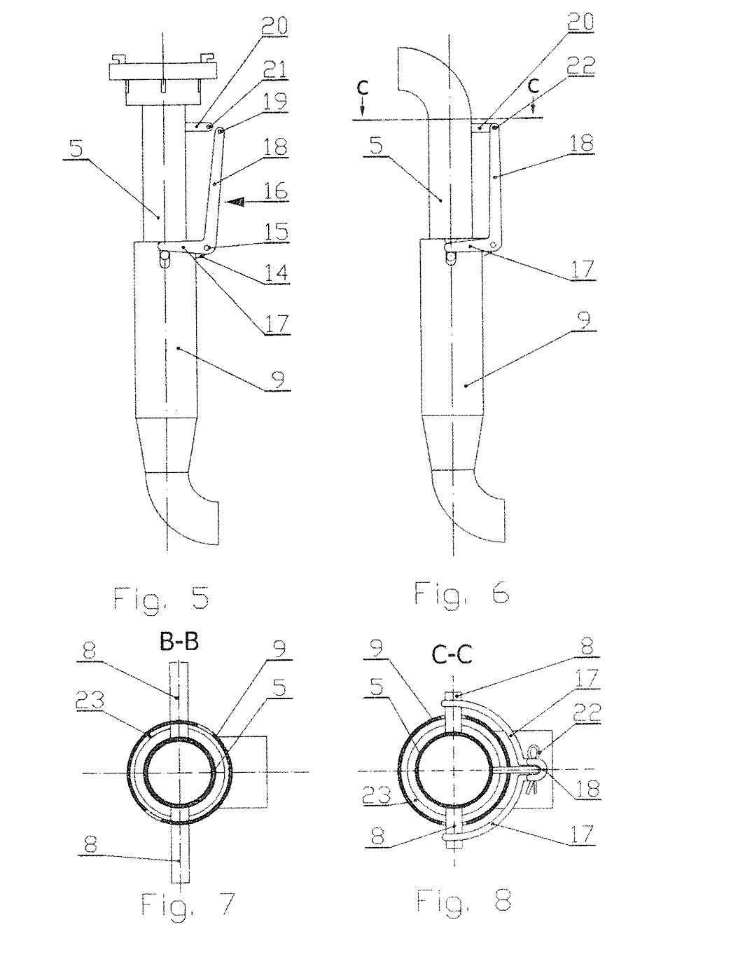

FIG. 4 represents detail B in FIG. 2,

FIG. 5 represents a side view of the quick-connectors in FIG. 3, in the second example embodiment,

FIG. 6 represents a side view of the quick-connector as in FIG. 4, in the second example embodiment, and

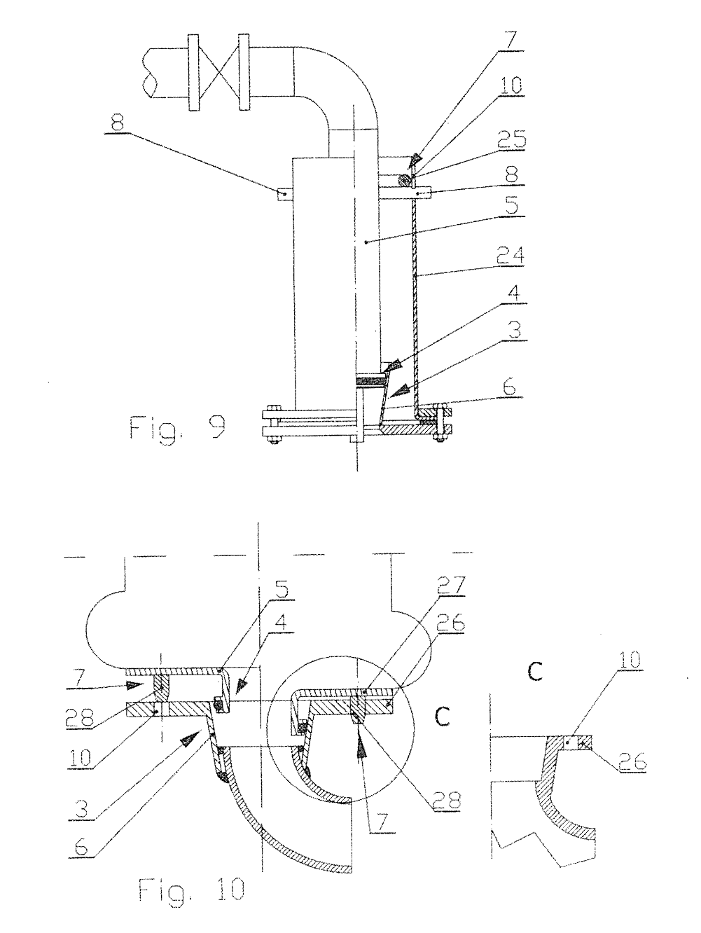

FIG. 7 represents, a magnified projection from above of section B-B of the quick-connector from FIG. 1, furthermore,

FIG. 8 represents a magnified projection from the top of section of the quick-connector from FIG. 6,

FIG. 9 represents a side view the quick-connector in half-section of the third example embodiment, placed in a sheathing column as a rinsing-receiving system,

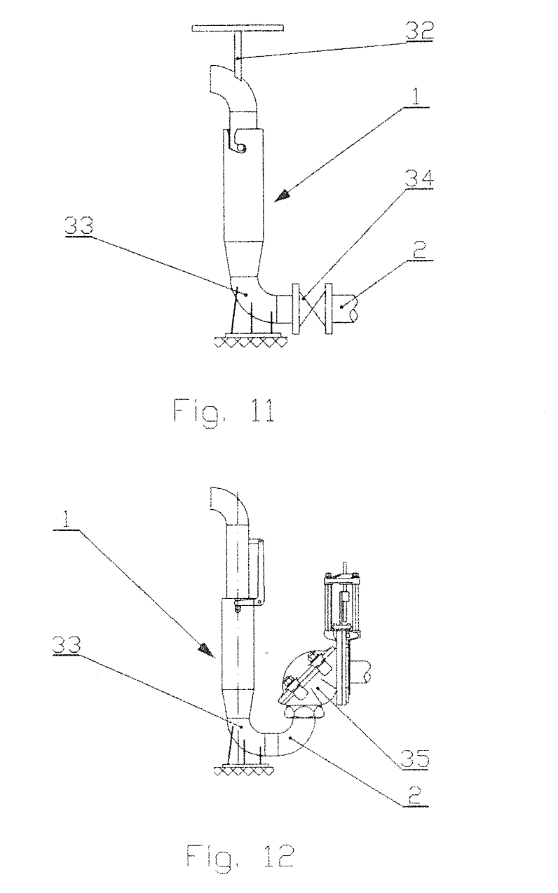

FIG. 10 represents a lengthwise section of the quick-connector of the fourth example embodiment,

FIG. 11 represents a side view of the quick-connector of the first example embodiment attached on a base and terminating in a shutoff valve, and

FIG. 12 represents a side view of the quick-connector of the second example embodiment mounted on a base and terminating in a combo return valve,

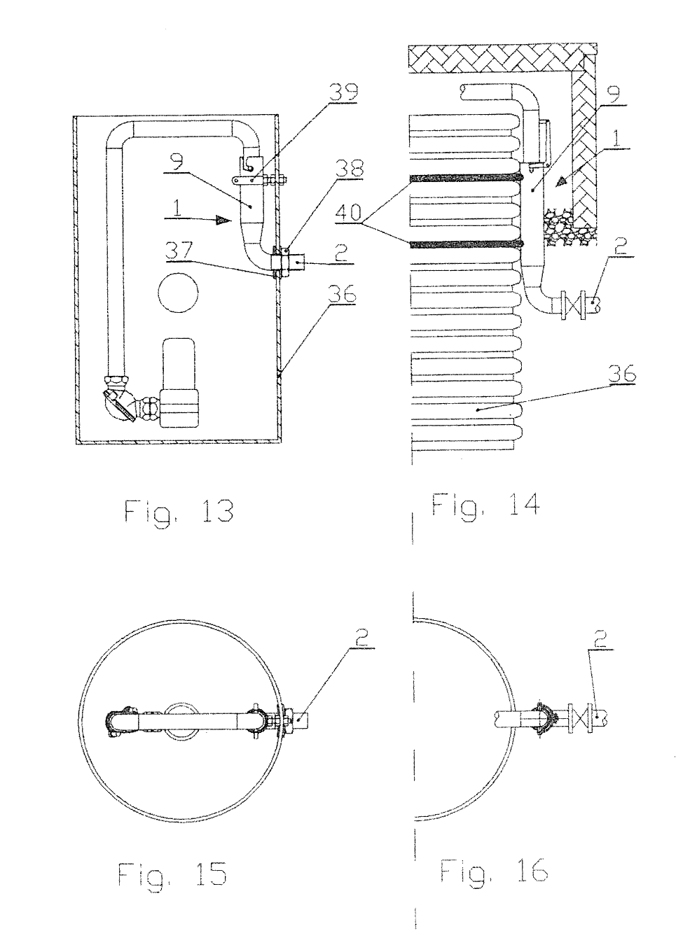

FIG. 13 schematically represents a sewage pumping station using a sewage quick-connector from the first example embodiment, side view,

FIG. 14 schematically represents a sewage pumping station using a sewage quick-connector from the second example embodiment, side view,

FIG. 15 schematically represents a top view of the pumping station from FIG. 13, and

FIG. 16 schematically represents a top view of the pumping station from FIG. 14.

A quick-connector according to the present invention shown in FIGS. 1-4, of the first example embodiment, possesses an inflow/outflow conduit 2 terminating in a sealing flange 3, a sealing piston 4 is mounted at the end of compression pipe 5, wherein sealing piston 4 possesses on its lateral surface at least one elastic seal, which seals the connection with the sealing flange, on its internal surface. The sealing flange 3 is made in the form of a symmetrical funnel 6 widened at one end, and the compression pipe 5 possesses a guiding element 7, which determines the essentially coaxial conduct of the compression pipe 5 with the sealing piston 4, upon its connection to and disconnection from the internal surface of the symmetrical funnel 6 of the sealing flange 3. To the external surface of the compression pipe 5 there are attached at least two perpendicular compression studs 8, and the widened end of the symmetrical funnel 6 is mounted with a guiding pipe 9, on whose end are guiding grooves 10 to guide compression studs 8 along with the compression pipe 5, upon its connection to and disconnection from the internal surface of the symmetrical funnel 6 of the sealing flange 3. The guiding grooves 10, made in the end of the guiding pipe 9, are mirror-image symmetrical to each other and possess bevelled edges 11 terminating in angled bevels 12 at an angle _ in relation to the axis of symmetry of the guiding pipe 9, which angle is in the range of 45° to 88°. The bevelled edges 12 are positioned at an angle _ in relation to the axis of the compression pipe 5, contained preferentially in the range of 75° to 83°, and the bevelled edges 12 terminate with an opening 13 with a diameter larger than the diameter of the guiding grooves 10, wherein the bevelled edge 12 of the guiding pipe 9, located closer to the end of the widened end of the symmetrical funnel 6, abuts the opening 13.

The operation of this quick-connector is based on the fact that the compression pipe is introduced into the guiding pipe 9, such that the compression studs 8 enter the guiding grooves 10, and the guiding element 7 enters the guiding pipe 9. Next, the guiding pipe 9 is pressed in the direction of the symmetrical funnel 6 of the sealing flange 3 and then it is twisted to the side such that the compression studs 8 enter opening 13. The disconnection of the quick-connector is performed by acting in reverse.

In the quick-connector according to the present invention, as was shown in FIGS. 5-8, of the second example embodiment, the guiding pipe 9 is equipped with a lever support 14 with a lever aperture 15, which possesses a rotating lever 16 possessing two symmetrical compression arms 17 as well as a mounting arm 18 mounting aperture 19, whereas the compression pipe 5 possesses a compression connector 20 with compression aperture 21, which serves to block the mounting arm 18 of the lever 16. Lever 16 is blocked by the connection of the mounting aperture 19 of the mounting arm 18 of the lever 16 with the compression aperture 21 of the compression support 20 using a cotter pin 22.

The operation of this quick connector is based on the fact that the compression pipe 5 is introduced into the guiding pipe 9, such that the compression studs 8 enter the guiding grooves 10, and the guiding element 7 enters the guiding pipe 9. Next, the guiding pipe 9 is pressed in the direction of the symmetrical funnel 6 of the sealing flange 3 using the lever 16, whose compression arm 17 pushes the compression studs 8. The lever 16 is blocked using a cotter pin 22 through using it to connect the mounting aperture 19 of the mounting arm 18 of the lever 16 with the compression aperture 21 of the compression support 20. Disconnection of the quick-connector is performed by acting in reverse.

The guiding element 7 of the quick-connector according to the present invention, in the first and second example embodiments, is mounted is on the compression pipe 5 opposite the sealing piston and possesses a guiding seal 23 with a diameter equal to or slightly smaller than the internal diameter of the guiding pipe 9.

Such placement of the guiding seal 23 causes an increase in quick-connector stability and the maintenance of its integrity during asymmetrical loading of the compression pipe 5. The compression pipe 5 may be connected to a pump or may be a rinsing pipe, as shown in FIG. 5.

In a quick connector according to the present invention, as shown in FIG. 9, of the third example embodiment, the external surface compression pipe 5 is equipped with at least two perpendicular compression studs 8, a sheathing pipe 24 is mounted directly or indirectly to the sealing flange 3, said pipe has an internal diameter greater than the symmetrical funnel 6 of the sealing flange 3, whose end contains guiding grooves 10 to guide the compression bolts 8 along with the compression pipe 5, upon its connection to and disconnection from the symmetrical funnel 6 of the sealing flange 3 via the sealing piston 4. The guiding element 7 is mounted on the compression pipe 5 opposite the sealing piston 4 in the form of a concentrically mounted ring 25 attached to the compression bolts 8 with a diameter equal to or slightly larger than the internal diameter of the sheathing pipe 9.

This type of quick-connector may be used in the sheathing columns of aerating/deaerating systems for transferring potable water, industrial water and sewage, which subunits may be quickly exchanged for rinsing-receiving sets. The operation is similar to that of the quick-connector from the first example embodiment, wherein the compression studs 8 are tightened on the sheathing pipe 24.

In the quick connector according to the present invention, as shown in FIG. 10, in the fourth example embodiment, the widened end of the symmetrical funnel 6 of the sealing flange 3 is equipped with a perpendicular guiding flange 26, which possesses guiding grooves 10, and to the compression pipe 5, opposite the sealing piston 4, there is attached a perpendicular compression flange 27 possessing at least two guiding elements 7 in the form of guiding studs 28, which, along with compression pipe 5, migrate in an essentially slide wise motion through the guiding grooves 10 upon its connection to and disconnection from the symmetrical funnel 6 of the sealing flange 3.

This solution may be used in pumping installations with a dry chamber, where the connection and disconnection time of the pump on the suction side is greatly reduced.

A sealing piston 4 in a quick-connector according to the present invention, in the first, second and third example embodiment, possesses a terminal flange 29 as well as a middle flange 30, between which is wedged an o-ring seal 31 with an external diameter larger than the external diameter of the flanges, and smaller than the largest internal diameter of the symmetrical funnel 6 of the sealing flange 3.

The small slope of the walls of the symmetrical funnel 6 of the sealing flange 3 in relation to its axis of symmetry, some 5° to 20°, most preferentially, j 7° to 15° causes the very strong compression of the o-ring seal 31 with small compression forces, which is a very large advantage over a terminal seal, and in relation to a side cylindrical seal ensures greater stability and durability. Such sloping walls of the symmetrical funnel 6 renders a great tolerance in manufacturing a quick-connector according to the present invention, which in turn greatly lowers its manufacturing costs. The o-ring seal 31 may be produced from for example of. Viton or another elastic-resilient material with extensive shape memory, and its hardness may be selected depending on the type of quick-connector, the type and pressure of the medium in the inflow/outflow conduit 2.

In a quick connector according to the present invention, in the first, second and third example embodiment, the compression pipe 5, opposite the sealing piston 4 is equipped with a compression rod 32, as shown in FIG. 11. This facilitates the assembly and disassembly of the compression pipe 5 in the guiding grooves 10, when the pump-hydrant quick-connector 1 is deeply recessed.

In a quick connector according to the present invention, as shown in FIG. 11, in the first, second, and third example embodiment, inflow/outflow conduit 2 is connected with a stopper elbow 33, which is terminated with a shutoff valve 34. Such a solution may be used in household sewage pumping stations with an accessible tank, when the pump-hydrant quick-connector 1 is deeply recessed.

In a quick connector according to the present invention, in the first and second example embodiment, the inflow/outflow conduit 2 is connected with a stopper elbow-bend 33, terminating with an elbow-mounted return valve with a shutter gate 35. This solution is recommended for using the pump-hydrant quick-connector 1 in household sewage pumping stations with an accessible tank for inflow/outflow conduit 2 diameters equal to or greater than DN 50.

The pumping station, shown in FIGS. 13-16 possesses a tank with a sealed bottom with an inflow and contains a pump-hydrant quick-connector 1 made according to the first and second example embodiments, which is attached directly to the side wall of the tank 36.

In the first embodiment variant of pumping stations according to the present invention, as shown in FIG. 13 and FIG. 15, the pump-hydrant quick-connector 1 is attached directly to the internal wall of the tank 36. The inflow/outflow conduit 2 of the pump-hydrant quick-connector 1 penetrates the tank through a sealed passage through the tank 36 to the outside and is mounted rigidly on the tank 36 wall using a plate 37 tightened with a nut 38 as well as a compression band 39 tightened on the main pipe 9 mounted rigidly on the side of the tank wall 36.

This solution is recommended for household sewage pumping stations with inaccessible tanks. This simplifies the construction of sewage pumping stations and lowers their manufacturing costs.

In the second embodiment variant of pumping stations according to the present invention, as shown in FIG. 14 and FIG. 16, the pump-hydrant quick-connector 1 is attached directly to the corrugated side of the tank 36. The guiding pipe 9 of the pump-hydrant quick connector is mounted to the is to external corrugated side of the tank 36 using at least two bands 40 mounted in ring grooves in the corrugated tank wall 36.

This solution is, in turn, recommended for the smallest diameter inaccessible tanks in sewage pumping stations. In temperate and cold zones, the tank 36 of pumping stations according to the present invention requires thermal sheathing on the sides and top, with a bottom draining layer, as shown for example in FIG. 14.

The above examples do not exhaust all possible embodiments and uses of the device according to the present invention, encompassed by patent claims from 1 to 20.

1. A pump-hydrant quick-connector which contains a an inflow/outflow conduit ending in a sealing flange and a compression pipe, which possesses a sealing piston at its end, wherein the piston possesses on its lateral surface at least one elastic seal, which seals the joint between the sealing flange on its inner surface, characterised in that the sealing flange (3) is in the form of a symmetrical funnel widened at one end (6), the compression pipe (5) possesses a guiding element (7), which determines the co-axial positioning of the compression pipe (5) with the sealing piston (4), upon connection to and disconnection from the interior surface of the symmetrical funnel (6) of the sealing flange (3).

2. A quick-connector according to claim 1, characterised in that do the exterior surface of the compression pipe (5) possesses at least two compression bolts (8), and to the widened end of the symmetrical funnel (6) there is attached a guiding pipe (9), whose end possesses two guiding grooves (10) guiding the compression bolts (8) along with the compression pipe (5), by way of its connection and disconnection from the interior surface of the symmetrical funnel (6) sealing flange (3).

3. A quick-connector according to claim 2, characterised in that the guiding grooves (10), made in the end of the compression pipe (5), are symmetrical in a mirror-image reflection of each other, and possess elongated edges (11) terminating in angled bevels (12) at an angle α in relation to the axis of symmetry of the compression pipe (5), ranging from 45° to 88°.

4. A quick-connector according to claim 3, characterised in that the angled bevels (12) are at an angle _ in relation to the compression pipe (5), preferentially in the range from 75° to 83°, an the angled edges (12) terminate in an opening (13) with a diameter wider than the guiding grooves (10), wherein the angled edge (12) of the guiding pipe (9), positioned closer to the widened end of the symmetrical funnel (6), is adjoining the opening (13).

5. Quick-connector according to claim 2, characterised in that do the guiding pipe (9) is equipped with a lever support (14) with a lever opening (15), which has a rotating lever (16) mounted onto it which possesses two symmetrically positioned compression arms (17) and a mounting arm (18) with an attachment aperture (19).

6. A quick-connector according to claim 5, characterised in that the compression pipe (5) possesses a compression support (20) with a compression aperture (21), which is used to block the mounting arm (18) of the lever (16).

7. A quick-connector according to claim 6, characterised in that the lever (16) is blocked by the connection of the mounting aperture (19) the mounting arm (18) and lever (16) with the compression aperture (21) of the compression support (20) with a cotter pin (22).

8. A quick-connector according to claim 1-7, characterised in that the guiding element (7) is mounted on the compression pipe (5) on the opposite side of the sealing piston and possesses a guiding seal (23) with a diameter equal to or slightly smaller than the internal diameter of the guiding pipe (9).

9. A quick-connector according to claim 1, characterised in that do the exterior surface of the compression pipe (5) is equipped with at least two compression bolts (8), and the sealing flange (3) is directly or indirectly mounted with a sheathing pipe (24), with an internal diameter greater than the symmetrical funnel (6) sealing flange (3), on whose end there are the (10) for guiding the compression bolts (8) along with the compression pipe (5), upon its connection to and disconnection from the symmetrical funnel (6) sealing flange (3) via the sealing piston (4).

10. A quick-connector according to claim 9, characterised in that the guiding element (7) is attached to the compression pipe (5) on the opposite side of the sealing piston (4) in the form of a concentric circle (25) attached to the compression bolts (8), with an internal diameter equal to or slightly lesser than the internal diameter of the interior sheathing pipe (24).

11. A quick-connector according to claim 1, characterised in that the widened end of the symmetrical funnel (6) sealing flange (3) is equipped with a perpendicular guiding flange (26), which possesses guiding grooves (10), and the compression pipe (5), opposite the sealing flange (4), possesses a perpendicular compression flange (27) possessing at least two guiding elements (7) in the form of guiding studs (28), which, along with the compression pipe (5), pass through the guiding grooves (10) upon the connection to and disconnection from the symmetrical funnel (6) sealing flange (3).

12. A quick-connector according to claims 1-11, characterised in that the sealing piston (4) possesses an end flange (29) and a middle flange (30), with an o-ring seal (31) between them with an external diameter larger than the external diameter of the flanges, and smaller than the largest internal diameter of the symmetrical funnel (6) sealing flange (3).

13. A quick-connector according to claims 1-10, characterised in that the compression pipe (5), opposite the sealing piston (4) possesses a sealing rod (32).

14. A quick-connector according to claims 1-10, characterised in that the inflow/outflow conduit (2) is connected with a stopper knee-bend (33), at whose end is a shut-off valve (34).

15. A quick-connector according to claims 1-8, characterised in that the inflow/outflow conduit (2) is connected to a stopper knee bend (33) with a knee-bend return valve with an integrated shutter valve (35) mounted on its end.

16. A pumping station possessing a tank with a sealed bottom with a conduit leading to it, containing a pump-hydrant quick-connector possessing a compression pipe, which possesses a sealing piston on its end as well as an inflow/outflow conduit terminating in a sealing flange in the form of a symmetrical funnel widened at the end to which is attached a guiding pipe, at whose end there are guiding grooves for guiding the compression bolts along with the compression pipe, upon its connection to and disconnection from the interior surface of the symmetrical funnel sealing flange, wherein the sealing piston possesses on its lateral surface at least one elastic seal, which seals the connection with the sealing flange on its internal surface, characterised in that the pump-hydrant quick-connector (1) is mounted directly on the side wall of the tank (36).

17. A pumping station according to claim 16, characterised in that the pump-hydrant quick-connector (1) is mounted directly on the side wall of the tank (36).

18. A pumping station according to claim 17, characterised in that the inflow/outflow conduit (2) penetrates the tank wall (36) via a sealed joint to the outside and is solidly mounted in the tank wall (36) with a flange (37) compressed with a nut (38) and a compression band (39) compressed onto the guiding pipe (9) solidly affixed to the side wall of the tank (36).

19. A pumping station according to claim 16 characterised in that the pump-hydrant quick-connector (1) is affixed directly to the external, corrugated surface of the tank (36).

20. A pumping station according to claim 19 characterised in that the guiding pipe (9) is mounted on the external, corrugated surface of the tank (36) using at least two bands (40) mounted in ring grooves of the corrugated walls of the tank (36).
